(19) United States
(12) Patent Application Publication
(10) Pub. No.: US 2006/0120580 A1
(43) Pub. Date: Jun. 8, 2006

(54) Characterizing, surfaces in medical imaging

(76) Inventors: Sherif Makram-Ebeid, Dampierre (FR); Jean-Michel Rouet, Paris (FR); Maxim Fradkin, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/526,192

(22) PCT Filed: Aug. 22, 2003
(86) PCT No.: PCT/IB03/03775

§ 371 Date: Mar. 1, 2005

(30) Foreign Application Priority Data
Sep. 4, 2002 (EP) 02292173

(51) Int. Cl. G06K 9/00

(52) U.S. Cl. 382/128

(57) ABSTRACT

The invention relates to a medical image processing system comprising means for identifying a boundary of the object, and reference points of said object boundary within an observation window; and for decomposing said object boundary into boundary unit elements, centred at the reference points, means for coding each reference point including spatial information and intensity information relating to said reference point and the corresponding unit element; computing transform coefficients from said coding data. A finite number of said coefficients is used for representing said object boundary by a polynomial transform function. This system has means for comparing, matching, correlating, smoothing corresponding boundary portions of the object in different images, only by performing operations on the transform coefficients. These operations yield rotation, translation, scale change transform coefficients.

### FIELD OF THE INVENTION

The invention relates to an image processing system having image data processing means for characterizing boundaries of regions in an image and for matching surfaces in medical imaging. The invention also relates to a medical examination apparatus having such an image processing system. The invention further relates to an image processing method having steps for operating the system and to a computer program product having instructions for carrying out the method steps. The invention finds its application in the field of medical imaging and, more especially, in the field of x-ray medical imaging.

When analyzing 3D medical images, it is often useful to match a discrete surface model to the boundary of an anatomical object. This can help, for example, in extracting the object from other unrelated objects for improving the visualization of said object. Among many other applications, such discrete surface model allows to make clinical measurements such as linear dimensions, boundary surface area, cross-sectional area, enclosed volume of an organ. It is also often desirable to compare or match active surface models with respect to one another.

### BACKGROUND OF THE INVENTION

A publication entitled “Edge Dipole and Edge Field for Boundary detection”, pp.179-189, in “Part of the SPIE Conference on Hybrid Image and Signal Processing VI, ORLANDO, Fla., April 1998, SPIE Vol. 3389”, by Toshiro KUBOTA et al., proposes a framework for treating edges as directional dipoles that induce a field around themselves. This paper treats edges not only as vectors but also as dipoles, which induce a vector field around them. Thus, said dipoles are called edge dipoles and the field is called edge field. An analogy is made between this concept and the interaction of magnetic dipoles with the magnetic field. The field induced by an edge dipole exhibits smooth continuous flows from the positive pole to the negative pole. The field in turn can be used to rotate other dipoles to align with the field. The approach of this paper provides an interaction mechanism between the dipole and the field, which has an influence on the edges. Also, the edge dipole field has circular flows diverging at the positive pole and converging at he negative pole, which provides a convenient mechanism for lateral inhibition and discourages thick boundaries from forming. The dipoles interact with the field and align themselves into a smooth contour configuration. This concept is used in edge linking in order to complete missing image information. So, according to the disclosed method, it is needed to compute the influence of the dipoles within the region surrounding them in the images themselves.

### SUMMARY OF THE INVENTION

The present invention has for an object to provide an image processing system having processing means for characterizing the boundaries of regions using edge dipoles without computation related to the image region itself. The present invention has further for an object to provide such an image processing system for analyzing an anatomical surface of interest for comparing, matching or adapting a geometric model with anatomical object boundaries observable in a medical image, and/or a geometric model with another geometric model, and/or real image data with other image data of anatomical object boundaries observable in a medical image. Using the proposed system, substantial portions of the objects can be matched together in a patch wise approach. The output of the present system is valid whether the objects are virtual, such as active models, or are real such as represented by real image data. A basic principle of the invention is to represent a boundary of an object by dipoles alike a set of small elemental magnets. Each dipole characterizes an element of the boundary. Each dipole has a strength proportional to the size of the boundary element, is normal to said boundary element and oriented toward a direction regarded as outward direction with respect to the object limited by the boundary. This system means are recited in claim 1.

The image processing system can be implemented as a specially programmed general-purpose computer. The image processing system can be a workstation. According to the invention, an image processing method having steps for operating such this system is also proposed. The present invention yet further provides a computer program product having a set of instructions, when in use on a general-purpose computer, to cause the computer to perform the steps of this method. The present invention still further provides a medical examination apparatus incorporating the image processing system putting into practice this method in order to process medical image data obtained by the imaging apparatus, and means for visualizing the image data produced by said method. The visualization means typically consists of a monitor connected to the image processing system. Advantageously, the workstation and image processing system of the present invention are interactive, allowing the user to influence clinical data that are evaluated and/or the manner in which evaluated data is to be visualized.

### BRIEF DESCRIPTION OF THE DRAWINGS

The invention and additional features, which may be optionally used to implement the invention to advantage, are described hereafter with reference to the schematic figures, where:

FIG. 1A illustrates dipoles associated to a boundary of an object and FIG. 1B illustrates the definition of the polynomial function parameters; FIG. 1C illustrates a Dirac function;

FIG. 2 is a block diagram illustrating elements of a medical examination apparatus, incorporating a medical viewing system;

FIG. 3A is a flow diagram showing the main steps of an image data processing method for characterizing a boundary and FIG. 3B is a flow diagram showing the main steps of an image data processing method for matching two boundaries;

FIG. 4A illustrates a starting mesh model and FIG. 4B illustrates a step of fitting the model to a heart cavity;

FIG. 5 illustrates the mesh model that matches the heart cavity.

### DESCRIPTION OF EMBODIMENTS

An image processing method for characterizing boundaries of regions in an image is first described. The invention further relates to the application of this method to process medical images for improving the visualization of an anatomical surface of interest. The present image processing method may be used for analyzing an anatomical surface of interest for comparing, matching or adapting a geometric model with anatomical object boundaries observable in a medical image, and/or a geometric model with another geometric model, and/or real image data with other image data of anatomical object boundaries observable in a medical image. Matching together substantial portions of the objects can be performed in a patch wise approach. The present invention preferably makes use of mathematical tools based on a polynomial function such as the Hermite transform, also known as Hermite wavelets. This mathematical tool is succinctly described hereafter to facilitate computation steps that are advantageous to carry out the method of the invention.

In a 2D or 3D image, the image intensity f is defined in function of the location of each image pixel or image voxel. So, in a 2D image, the scalar value image intensity f is given as function of the real positional coordinates x, y. A positive valued function w(x, y) is introduced to define a fuzzy observation window W in the 2-D image. Geometric moments are defined as a set of quantities:
M_{m,n}=∫∫w(x,y)f(x,y)x^{m}yⁿdx dy (1)
The whole family of moments provides an alternative representation of the image f(x, y) that fully and uniquely characterizes the intensity f(x, y) within the observation window w(x, y). In practice, lower orders of the data (m, n) are the most robust whereas higher orders are more delicate to compute numerically and are more noise-sensitive. These moments are powerful in coding morphological information, but they have two shortcomings:

a) When comparing two images together, within a similar observation window, it is not obvious how similarity/dissimilarity measures of their moment representation relate to similarity/dissimilarity of the original images.

b) It is tedious to work out a comprehensive set of related measures that are invariant under a transformation group.

In order to solve these shortcomings a) and b), instead of using monomials x^{m}yⁿ in (1) one can use polynomials P_{m,n}(x, y), which are mutually orthogonal within the observation window w(x, y) in the sense that:
C_{m,n}δ_{m,m′}δ_{n,n′}=∫∫w(x, y)P_{m,n}(x, y)P_{m′,n′}(x, y)dx.dy (2)
where each δ_{m,m′}and δ_{n,n′}are equal to 1 if the two integers indices (m,m′) or (n,n′) coincide and to 0 otherwise, and where C_{m,n}>0 is referred to as the norm of the polynomial P_{m,n}(x, y). In fact it is possible to build a complete set of orthogonal polynomials provided the window function w(x, y) is never negative. Such a polynomial basis can provide least mean square approximation of an arbitrary function f(x, y) inthe form:

$$f ( x , y ) = {\sum }_{m , n} {f}_{m , n} \cdot {P}_{m , n} ( x , y ) / {C}_{m , n} \qquad ( 3 )$$

where the 2-D Hermite coefficients f_{m,n} are given by:
f_{m,n}=∫∫w(x, y).P_{m,n}(x, y).f(x, y).dx dy (4a)
Here, the coefficients f_{m,n} replace the geometric moments M_{m,n} defined in the previous paragraph. Those new coefficients are referred to as orthogonal moments. An important property answers the requirement a) stated at the beginning of the current section. This theorem, called Parseval's theorem, says that the scalar products are conserved. So, considering any two real-valued images f(x, y) and g(x, y) with respective orthogonal moments f_{m,n} and g_{m,n}, it is seen that taking the scalar products in transformed space, where the orders m and n play the role of coordinates, is the same as taking the product in x,y space:

$${\sum }_{m , n} {f}_{m , n} {g}_{m , n} / {C}_{m , n} = \int \int w ( x , y ) f ( x , y ) g ( x , y ) ⅆ x ⅆ y \qquad ( 5 )$$

This relationship can be deduced from the orthogonality of the polynomial functions P_{m,n}. It is noteworthy that the normalization factors 1/C_{m,n} play in the m,n space, the role that the window function w(x, y) plays in the x, y space.

The second shortcoming b) of the geometric moments is that the moments do not transform easily with changes of referential. Therefore, it is required to simplify transformations of the orthogonal moments with change of referential.

An advantageous way of doing this is to choose Hermite polynomials. This corresponds to taking for the window an isotropic Gaussian function centered about any reference point (ξ,η), so that:

$$w ( x , y ) = \frac{1}{2 {πσ}^{2}} \cdot exp ( - \frac{{( x - ξ )}^{2} + {( y - η )}^{2}}{2 {σ}^{2}} ) \qquad ( 6 )$$

This resulting transform is called the Hermite transform. The corresponding 2-D polynomial basis can be expressed in term of products:
P_{m,n}(x,y)=Hₘ(x).Hₙ(y) (7)
where Hₘ and Hₙ are Hermite polynomials of orders m and n respectively. The corresponding normalization factors are:
C_{m,n}=2^{m+n}m!n! (8)

Since an object of the invention is to compare images together, it is needed to easily deal with geometric transformations.

Dealing with translations is first described: The Hermite coefficients f_{m,n} of function f( ) can be expressed in terms of partial derivatives of a smoothed function F( ) obtained by convolving f( ) with the Gaussian kernel w( ). Those skilled in the art can easily demonstrate that:

$${f}_{m , n} = {2}^{\frac{m + n}{2}} \cdot {( - σ )}^{m + n} \cdot \frac{{\partial }^{m + n} F}{\partial {x}^{m} \partial {y}^{n}} {\vert}_{x = ξ , y = η} \qquad ( 9 )$$

This form allows to obtain the effect of translation by a simple application of Taylor theorem where the coefficients are directly related to the Hermite transform coefficients f_{m,n}. The fact that a Gaussian smoothing was obtained to evaluate F implies that it is enough to use very few terms for the Taylor expansions provided one stays within a disk of radius 1 or 2σ from the original window centre.

Dealing with rotations is then described: To deal with 2D rotations, the most suitable related transform is that of Gauss-Laguerre transform described in the following publication by G. Jacovitti and A. Neri; “Multiresolution Circular Harmonic Decomposition”, IEEE Transactions on Signal Processing, vol. 48, pp. 3242-3247 (2000). This transform may be related to that of Hermite since the corresponding polynomials are related to solutions of the Quantum harmonic oscillator as described in the following publication by J. J. Koenderink and A. van Doorn; “Generic Neighbourhood Operators”, IEEE Transaction on Pattern Analysis and Machine Intelligence, vol. PAMI-14, pp. 597-605 (1992). Hermite polynomials result from seeking solutions using Cartesian coordinates whereas the Laguerre polynomials appearing in the Gauss-Laguerre transform result from the use of polar coordinates. The essential thing one needs to know is that, for any given order (p≡m+n) the two sets of solutions can be transformed into each other. The Cartesian set of polynomials can be written as products P_{m,n}(x,y)=Hₘ(x).Hₙ(y) whereas the polar form (Gauss-Laguerre) are in the form

$${Q}_{p , k} ( r ) \{ \begin{matrix}cos ( k θ ) \\ sin ( k θ )\end{matrix} \} \qquad ( 10 )$$

where Q_{p,k}(r) is a function of the radial coordinate r=\sqrt{x²+y²} and θ is the angular polar coordinate. The order k of the circular harmonic factor spans all integers in the interval [0, p] with same parity as p (for k=0 only one circular harmonic exists, namely the constant 1). It is easily seen that, for both representations, there are exactly (p+1) independent functions. In order to find the (p+1)² matrix that transforms the Hermite into Gauss-Laguerre functions, it is enough to compare angular behaviours for very large r values. Elementary trigonometry can be used to express P_{m,n}(x,y)∝ cos^{m}(θ).sinⁿ(θ) in terms of the circular harmonic functions referred to earlier. It is also easily established that the same matrix can be used to transform coefficients from one basis to the other. One can also deduce the new normalization factors c_{m,n} from this matrix because both set of functions form orthogonal bases. In order to revert from Gauss-Laguerre back to Hermite, the inverse matrix is used.

Rotation with an angle Δθ is easily implemented because the coefficients C_{p,k} and S_{p,k} related to the Gauss-Laguerre functions Q_{p,k}(r).cos(kθ) and Q_{p,k}(r).sin(kθ) behave exactly like x and y components of a 2-D vector rotating with an angle kΔθ (for non-zero angular harmonic order k). Thus, a rotation would transform C_{p,k} and S_{p,k} to C′_{p,k} and S′_{p,k} such that

$$( \begin{matrix}{C}_{p , k}^{′} \\ {S}_{p , k}^{′}\end{matrix} ) = ( \begin{matrix}cos ( k Δθ ) & sin ( k Δθ ) \\ - sin ( k Δθ ) & cos ( k Δθ )\end{matrix} ) ( \begin{matrix}{C}_{p , k} \\ {S}_{p , k}\end{matrix} ) \qquad ( 11 )$$

Which is totally equivalent to the complex variables equation:
(C′_{p,k}+iS′_{p,k})=exp(ikΔθ)(C_{p,k}+iS_{p,k}) (12)
where i stands for the imaginary unit and Δθ stands for the rotation angle of the referential.

Dealing with scale changes is further described: Changing scale implies changing the Gaussian window function. However, one can alternatively imply the scale changes in the approximating polynomials P_{m,n}( ). Although this approach is relatively simple, it implies using a least-mean square approximation obtained within a given window for extrapolation into a larger window or for interpolation within a smaller window. Scale changes are most easily operated on monomials. The approach proposed is just to express the polynomials as a sum of monomials, operating scale change and then reverting back to the orthogonal representation. For Hermite polynomials, this can be expressed as matrix operations in the form H′=AΛA⁻¹H , where:

$$H = ( \begin{matrix}{H}_{0} ( x ) \\ {H}_{1} ( x ) \\ {H}_{2} ( x ) \\ …\end{matrix} ) , {H}^{′} = ( \begin{matrix}{H}_{0} ( λ x ) \\ {H}_{1} ( λ x ) \\ {H}_{2} ( λ x ) \\ …\end{matrix} ) , Λ = ( \begin{matrix}1 & 0 & 0 & 0 \\ 0 & λ & 0 & 0 \\ 0 & 0 & {λ}^{2} & 0 \\ 0 & 0 & 0 & …\end{matrix} ) \qquad ( 13 )$$

and where Λ is the lower triangular matrix allowing to express the column vector of Hermite polynomials in terms of the column vector of the powers of x. This allows to express Hₙ(λx) as a linear combination of original Hermite polynomials Hₚ(x) of equal or smaller order (and of same parity). The matrix A Λ A⁻¹ can be computed once for all, it is a sparse lower triangular matrix in which all non-zero coefficients are polynomials in λ of orders never exceeding the order of the line. Since 2-D Hermite polynomials are just products of 1D polynomials, this scaling operation is dimensionally separable. Exactly the same transformation applies to Hermite coefficients. Because of the sparseness of the matrices involved and of dimensional separability, scale changes are not computationally costly.

The above-described operations can be applied in images of more than two-dimensions: Most of the above-described operations easily generalize to any number of image dimensions. The only basic change is how one deals with rotations. Spherical harmonics have to replace circular harmonics. For 3-D, the corresponding spherical harmonic formulae can be found in classical mathematics handbooks and the conversion matrices from Cartesian (Hermite) to polar form (Laguerre) can recursively be evaluated as is done in 2-D. However, a rotation of the referential implies the use of difficult spherical harmonics addition formulae. Another formulation has been disclosed by the Clifford Algebra group of Ghent University by R. Delanghe, F. Sommen, V. Soucek, F. Brackx in “Clifford Algebra and Spinor-Valued Functions, A Function Theory of the Dirac Operator”, Kluwer Academic Publishers (1992). For the 3-D case, the approach proposed by this publication just needs the introduction of unit called “quaternions” to implement 3-D rotations of the Gauss-Laguerre coefficients, thus providing a generalization of the complex rotation factor exp(ikΔθ) as discussed in 2D case. Now, quaternions are entering the engineering field and are not considered to be exotic anymore in the image processing community, as described by B. Horn in “Closed Form Solutions of Absolute Orientation using Unit Quaternions” in Journal of the Optical Society, vol. A4, pp. 639-642 (April, 1987). The basic advantage in using the above set of proposals is to transform a set of image processing operations into hopefully simple algebraic forms. These mathematical tools may be used by those skilled in the art in order to perform the computation steps of the image processing method of the invention.

A method that applies this technique of characterizing a boundary using the function of intensity with the Hermite coefficients is described hereafter. The present image processing method has steps for computing Hermite coefficients in order to characterize a curve line or a boundary of an object in an image window by the Hermite transform. This method permits of modelling and extracting interfaces or boundaries of objects in medical images. For performing this operation, it is possible to compute Hermite Transform Coefficients of an object boundary regarded as an oriented interface by sampling the corresponding boundary. There is no need to get region data as described in the cited “KUBOTA” publication.

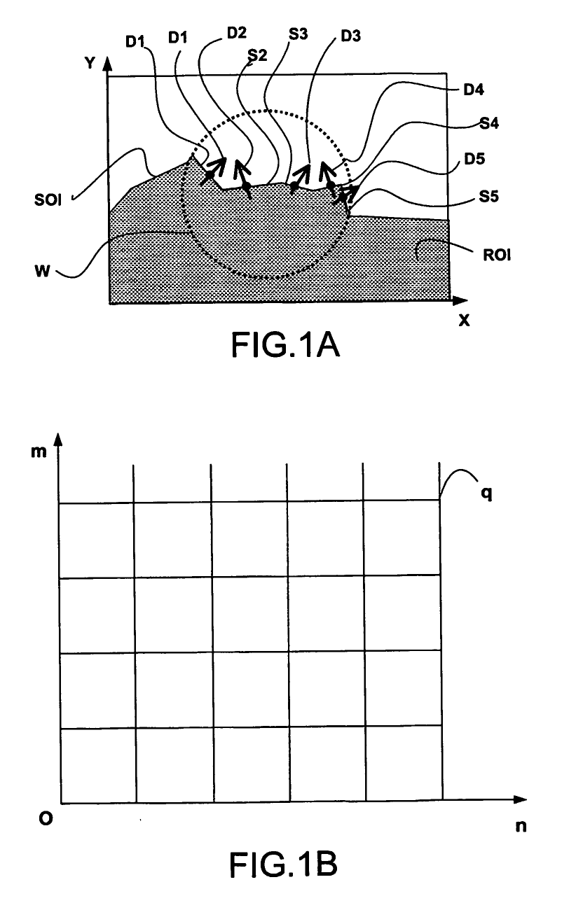

FIG. 1A represents schematically a region of interest ROI of an object in a two-dimensional (2-D) image. The region of interest ROI shows a 2-D boundary. A window W defines a portion SOI of the boundary that is considered. The 2-D boundary SOI is decomposed into small adjacent elementary linear elements, called segments, such as S1, S2, S3, S4, S5, respectively related to a predetermined number of boundary pixels, called reference pixels. Every segment such as S1-S5 of the boundary SOI in a 2D image is represented by a respective dipole D1, D2, D3, D4, D5. The arrows D1 to D5 illustrate the boundary dipoles. In 3-D images, the region of interest ROI shows a 3-D surface of interest SOI, called 3-D boundary, which is decomposed into small portions in a window W. Every small portion is represented by a dipole of strength proportional to the area portion of the 3-D boundary and oriented along the outward normal direction, at a defined centre of the small portion.

From such a representation, the Hermite transform can be computed within the window W as schematically represented in FIG. 1A for a 2-D image. The intensity of the boundary SOI in the window W is defined by a function of intensity f(x, y) where x, y are the coordinates of the reference pixels at the center of the segments or small portions. Assuming that the window centre is at the origin and that distances are normalized so that σ√2=1, the Hermite transform coefficients related to a dipole vector (Iₓ,I_{y}) at point (x,y) can be expressed as:
f_{m,n}=w(x,y).(Iₓ.Hₘ+1(x).Hₙ(y)+I_{y}.Hₘ(x).Hₙ+1(y)) (4b)
The Hermite transform of the interface dipole layer can be approximated as the sum of such contributions over all discrete interface elements in the window. Generalization to more than 2-D is again straightforward.

A first data, denoted by n, called spatial resolution, is related to the number of said segments in which the boundary is decomposed in said window W. A second data, denoted by m, called intensity resolution, is related to the number of possible gray levels for the pixels of the boundary in said window W. The definition of the data n, m is illustrated by FIG. 1B. Near point O, the spatial resolution n is low, meaning the number of segments is small while the segments are long; and the intensity resolution is low, meaning the number of gray levels is small. Instead near point p, the spatial resolution n is high, meaning the number of segments is large while the segments are small; and the intensity resolution is high, meaning the number of gray levels is large. The data n, m may be chosen a priori by the user. So, using the values of n, m near point O, the boundary SOI in the window W is characterized by a few number of long segments and a few number of gray levels. Instead, using the values of n, m near point p, the boundary SOI in the window W is characterized by a large number of small segments and a large number of gray levels.

In the present method, instead of regarding a boundary pixel directly, said boundary pixel is first coded using the above described technique. Each segment is characterized by a dipole, such as D1, D2, D3, D4, D5, located at the centre x,y of the segment, oriented along the outward normal direction of the object and having a strength that is defined using the spatial and intensity data related to the segment. The coding data include the first information related to the spatial resolution n and the second information related to the intensity resolution in the window W of the region of interest ROI. The spatial resolution n is considered as a first dimension and the intensity resolution m is considered as a second dimension for determining coding data related to a pixel at the location x, y. Alternately as shown in FIG. 1C, the segment may be coded by a Dirac intensity function having a highly positive value, outside the object, with respect to an axis directed along the dipole, and a highly negative value inside the object.

The major difference between the present invention and the technique disclosed in the publication “KUBOTA et al” cited above, is that instead of broadcasting the effect of each dipole in a portion of the image as was done in the known technique, the effect of each such dipole is integrated into transformed coefficients. The effects of those dipoles, such as D1-D5, within the window W, are cumulated as coefficients of an image transform procedure. The polynomial Hermite transform is advantageously used. As above-described, said Hermite transform is capable of coding the boundary inside the window using a finite number of coefficients. The contribution of each dipole element can be computed analytically knowing its position within the window, its strength and its orientation. The coding data form a series of two-dimensional (2-D) coefficients for defining said polynomial function. The number of 2-D coefficients is small when the coding data are chosen near point O of FIG. 1B, while the number of 2-D coefficients is large when the coding data are chosen near point p of FIG. 1B. The number of 2-D coefficients may be chosen within a range in which it may vary slowly, since the coding data n, m may be each chosen in a range in which they may vary slowly. According to the method of the invention, the boundary is characterized by said polynomial function with said 2-D coefficients in the window W. If the polynomial function is constructed with a great number of such 2-D coefficients, the representation of the boundary is smooth. If the polynomial function is constructed with a small number of coefficients, the representation of the boundary is coarse. Hence said polynomial function with said 2-D coefficients permits of classifying the representation of the boundary in a hierarchical manner, from coarse to fine, according to the number of coefficients used to construct the polynomial function. The medical viewing system and an image processing method of the present invention permit to minimize the load of computation produced by the KUBOTA et al. approach.

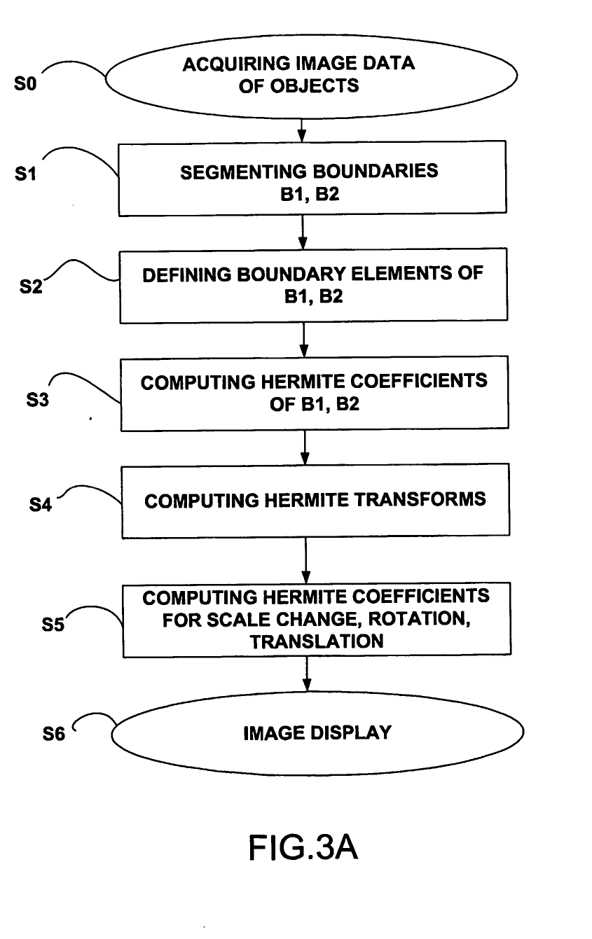

FIG. 3A is a flow diagram of main steps of the present method, comprising:

In step S0, acquisition of image data: The image data input to the method can be for example 3-D computed tomography image data obtained for a subject heart. The medical image data consists of a large number of data relating to points, each corresponding to a respective position within the patient's body. The image data can be submitted to preprocessing in order to eliminate noise. The method further comprises steps of:

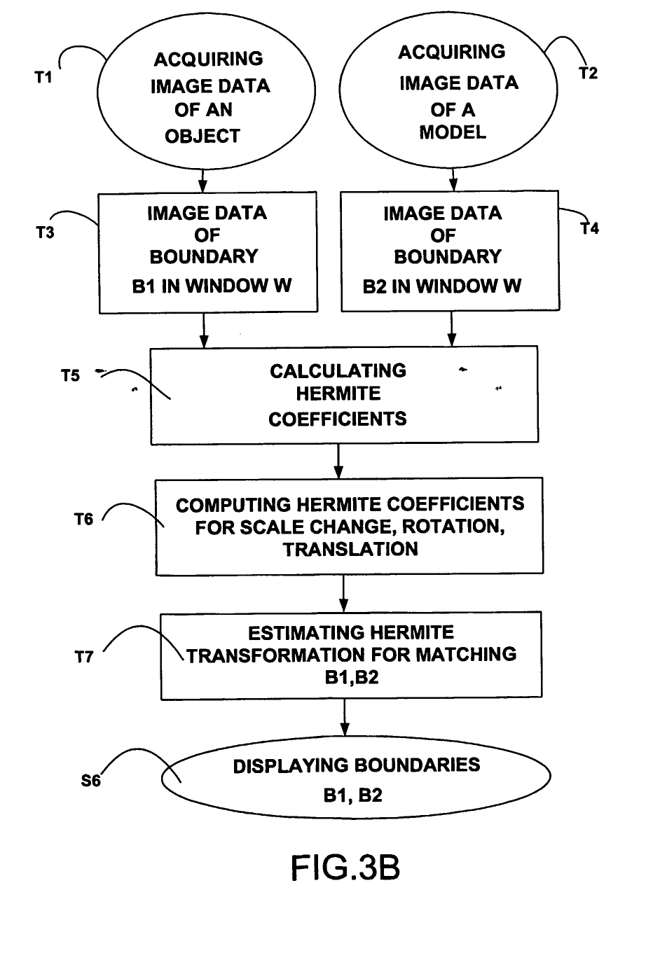

In step S1, computation of image data of an object surface denoted by B1 or B2. In step S1, the outer surface of the heart muscle, denoted by B1, is identified from within the image data via a segmentation process as illustrated by the segmented 2-D curved line or 3-D surface SOI in FIG. 1A. In another technique, the 3-D surface, denoted by B2, may be obtained as an active model providing a best fit to the heart muscle, or other anatomical object under consideration. Techniques for producing an active model of an anatomical object are well-known, for example by the description in the publication entitled “General Object Reconstruction Based on Simplex meshes” by Herve Delingette, in the International Journal of Computer Vision, 32, 111-142, 1999. Such a model is illustrated by FIG. 4A and FIG. 4C.

In step S2, decomposition of the boundary into 2-D elements of a 2-D curve line or small portions of a 3D boundary, such as B1 or B2, as above described in reference to FIG. 1A.

In step S3, characterization of the 2-D or 3-D boundary elements for example by dipoles or Dirac functions as illustrated by FIGS. 1A-1C; and computation of corresponding Hermite coefficients according to formulae (4a) or (4b).

In step S4, cumulating the effects of the dipoles D1 to D5 within the window W as coefficients of an image transform procedure. For example, one can use a Hermite transform that is capable of coding an image inside the window W using a finite number of coefficients. In this step, the contribution of each dipole element D1 to D5 in the window W is computed analytically knowing its position within the window, its strength and its orientation according to formulae (3), (4), (6) and (7).

In step S5, computation of the Hermite coefficients for translation, rotation and scale cange according to formulae (9), (11), (12), (13).

The Hermite transform of a boundary can now be used for different purposes. The present invention proposes a method having the steps described above and having further steps for matching two surfaces. For example this method has further steps to compare and/or to match a discrete model interface to another discrete interface; or to compare and/or to match a discrete interface to a real image. It is noted that the above proposals can substantially improve the performance and computational complexity of matching procedures. None of the above procedures requires to know a mapping from initial point position (prior to transformation) to a target position (after transformations) as is needed by the cited algorithms disclosed in the publication by B. Horn. So, the invention further relates to applying the first steps of characterizing the function of intensity of a boundary with the Hermite coefficients for comparing or matching two objects defined by curve lines or surfaces in corresponding windows. The operation of comparing or matching the boundaries of said two objects can be done only using the respective Hermite coefficients relating to their boundaries. The transformation needed to match a portion of interface with another one (registration or motion estimation) can be estimated for a pair of objects of same nature such as model with model or real data with real data; or of dissimilar nature such as model to data or data to model. The proposed method can be applied to medical image processing in order to enabling improved matching of surfaces such as an active model with anatomical object boundaries observable in a medical image, and/or an active model with another active model, and/or real image data with other image data of anatomical object boundaries observable in a medical image.

Hence, this method comprises steps for computing Hermite coefficients in order to characterize corresponding boundaries of two objects in an image window by the Hermite transform, including Hermite coefficients for translation, rotation, and scale changing and further steps for comparing or matching said two boundaries. Here, the template (or block-) matching, which is well known to those skilled in the art, can be transformed into matching of transformed coefficients. Rather than making exhaustive searches for translations, rotations, and scale changes in said template (or block-) matching operations, the mean square matching error can be written as an algebraic function of the transformation parameters. Optimal match between two boundaries can then be found by conventional gradient descent. Furthermore, it can be hoped that the simple algebraic form of the matching error can be exploited to efficiently locate all the local minima A rather interesting feature of the Hermite transform is that the set of coefficients for which one of the indices is 0 corresponds to the Hermite Transform of a “Weighted Radon” projection along axes corresponding to the 0 index. This may be useful, for example, for matching a 3-D pattern with a 2-D projection pattern.

Referring to FIG. 3B that is a flow diagram, this method comprises:

In steps T1, T2: respectively acquiring image data of first and second images. In the example described hereafter, in the first image the object is an organ represented by real data, and in the second image, the object is a virtual model of the organ having a boundary to be compared with a boundary of said organ. The interface of the virtual model is a binary region.

In steps T3, T4: respectively segmenting said images to provide image data of the corresponding boundaries respectively denoted by B1, B2 in the first and second images.

In step T5: calculating Hermite coefficients of the Hermite transforms for boundaries B1 and B2, as described in reference with steps S2, S3, S4 illustrated by FIG. 3A.

In step T6: deducing, as in step S5 illustrated by FIG. 3A, coefficients resulting from rotation, scale-change or translation of one object with respect to the other. The computations only require knowledge of the geometric transformation and of the Hermite coefficients before transformation.

In step T7: estimating the transformation needed to match the portion of boundary or interface of the model with the portion of boundary or interface of the organ, only using their respective Hermite coefficients.

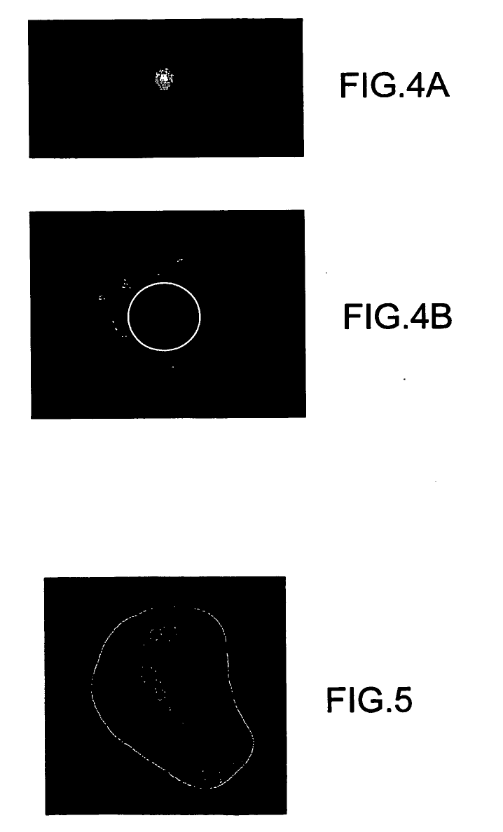

Another application is for performing registration or for motion estimation. Another application consists in smoothing an interface model through adapting it to a flat, or another appropriately shape target interface. FIGS. 4A illustrates an active model to be matched to heart cavity as shown in FIG. 4B. This model is deformed using internal and external forces in such a way as to fit the heart cavity. In order to determine the best match, the model surface boundary, as shown in FIG. 5, is compared to a segmented surface boundary of the heart cavity using the above-described method. In this first example, the above-described steps are used for estimating the transformation needed to match a portion of interface of objects of dissimilar nature, such as a model compared to real data or such as real data compared to a model. The above-described steps can also be used for estimating the transformation needed to match a portion of interface of a pair of objects of same nature, such as a model compared to a model or such as real data compared with real data. Then, each reference point of the reference surface is processed in turn and the normal to the reference surface is calculated at each reference point. All operations involved can be done in computationally efficient manner. The basic technique proposed here is generic; more than the cited operations may be carried out.

In general, the described method above, which is based on the technique of characterizing the function of intensity of a boundary with the Hermite coefficients of the Hermite transform of the boundary, can be used for purposes such as:

Adapting one contour to an image, which would consist in seeking a maximum of the correlation. This operation adapts the position of the dipoles in such a way as to maximize correlation of an interface with another interface called target interface. This can be used for example to model large portions of the boundary of an anatomical object using an active contour or active surface as model. This can be done by changing the dipole positions within the window (free-form adaptation) or by seeking optimal rotation, scale change and/or translation (global adaptation within the window). In fact, the operation of comparing or correlating the boundaries of said two objects can be done only using the respective Hermite coefficients relating to their boundaries.

Smoothing an interface model: this is possible through adapting it to a flat or appropriately shaped target interface. Smoothing such a boundary is performed by minimising the amplitude of higher order terms of the Hermite transform.

In another application, this method can be used to study noise or texture in images. This operation can be carried out using estimation of their autocorrelation. This consists in studying how the image correlates to a translated version of itself. An extension of this idea is to characterize the way the image correlates to itself when it undergoes, translation, scale changes and rotations. One should therefore estimate:
R(T)=<f(T⁻¹\vec{x})f(T\vec{x})>, where T and T⁻¹ are a transformation and its inverse.
   The windowed correlation product can be expressed algebraically in terms of the parameters defining the group of the geometric transformations T. If this group includes rotation, scaling and translation, the resulting autocorrelation function is rotation, scale and translation independent. If this is expressed in a functional form, coefficients characterizing this functional form can be extracted. For rectangular windows and when limiting T to mere translations, the functional form of the autocorrelation is characterized by the power spectral distribution (square of moduli of the Fourier transform) through the Wiener Khintchine theorem as described by W. H. Press, S. A. Teukolsky, W. T. Vetterling and B. P. Flannery; “Numerical Recipes in C, The Art of Scientific Computing”, Cambridge University Press, 1992 (2^{nd} Edition). Such characterisations of autocorrelation functions can be used to characterizing texture or the spectral behaviour of noise, and or providing an invariant set of characteristics of shapes for pattern recognition.

The above method for coding boundaries can be extended to other structures and to many applications. For example, oriented linear or tubular structures can be coded as a set of quadripoles. It is possible to put this transform in one of two forms: Hermite Cartesian form that is best suited to deal with translation or scale-change, and/or Gauss-Laguerre Polar form which is best suited to deal with rotations. Conversion from one form to the other is not computationally costly if one concentrates on low orders (i.e. when neglecting high frequency noise-prone terms in the expansions). Implementing these basic transformation operations can be done in a computationally efficient manner and can also be put in the form of compact algebraic expressions. Many practical applications can be envisaged as outlined in the previous section for putting the 3D rotation transformations into a mathematically correct framework and or characterizing the Generalized Autocorrelation function and relating it with invariant theories used in pattern recognition. An important advantage of Hermite transform is the ease and efficiency with which it can be put in forms that are particularly suited to deal with translation, rotation and scale change. Once the coefficients of the Hermite transform are known, one can deduce the coefficients resulting from rotation, scale-change or translation of the object. The computations only require knowledge of the geometric transformation and of the Hermite coefficients before transformation.

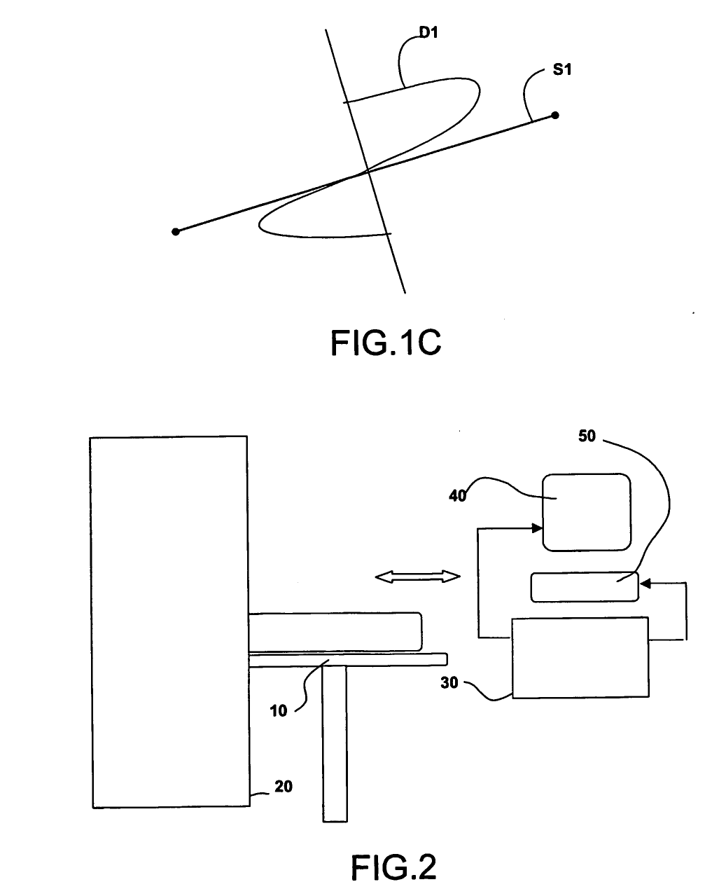

FIG. 2 shows the basic components of an embodiment of an image processing system in accordance to the present invention, incorporated in a medical examination apparatus. As indicated schematically in FIG. 2, the medical examination apparatus typically includes a bed 10 on which the patient lies or another element for localizing the patient relative to the imaging apparatus. The medical imaging apparatus may be a CT scanner 20. The image data produced by the CT scanner 20 is fed to data processing means 30, such as a general-purpose computer, that carries out the steps of the method. The data processing means 30 is typically associated with a visualization device, such as a monitor 40, and an input device 50, such as a keyboard, pointing device, etc. operative by the user so that he can interact with the system. The elements 10-50 constitute a medical examination apparatus according to the invention. The elements 30-50 constitute a image processing system according to the invention. The data processing device 30 is programmed to implement a method of processing medical image data according to invention. In particular, the data processing device 30 has computing means and memory means to perform the steps of the method. A computer program product having pre-programmed instructions to carry out the method may also be implemented.

The present invention is applicable regardless of the medical imaging technology that is used to generate the initial data. For example, when seeking to visualize the heart, magnetic resonance (MR) coronary angiography may be used to generate 3D medical image data in a non-invasive manner. See, for example, “Non-invasive Coronary Angiography by Contrast-Enhanced Electron Beam Computed Tomography” by Achenbach et al, in Clinical Cardiology, 21, 323-330, 1998. The Achenbach et al article includes useful information regarding optional data processing steps that can be applied to the medical image data, for example, segmentation to enable a representation of certain anatomical features in isolation from others, etc. These steps can be applied in the method of the present invention. The present invention is applicable regardless of the way in which a surface of interest is modeled, whether via use of a reference simplex mesh, or in some other way. Various modifications can be made to the order in which processing steps are performed in the above-described specific embodiment. The above-described processing steps applied to medical image data can advantageously be combined with various other known processing/visualization techniques. The drawings and their description hereinbefore illustrate rather than limit the invention. It will be evident that there are numerous alternatives that fall within the scope of the appended claims. Moreover, although the present invention has been described in terms of generating image data for display, the present invention is intended to cover substantially any form of visualization of the image data including, but not limited to, display on a display device, and printing. Any reference sign in a claim should not be construed as limiting the claim.

1. An image processing system comprising data acquisition means for acquiring image data of an object in an image and processing means for characterizing a boundary of the object comprising computing means for identifying the object boundary and reference points of said object boundary within an observation window; and for decomposing said object boundary into boundary unit elements, centred at the reference points;
this image processing system further comprising processing means for:
coding each reference point using coding data including spatial information and intensity information relating to said reference point and the corresponding unit element;
computing transform coefficients from said coding data;
representing said object boundary by a polynomial transform function using a finite number of said coefficients; and comprising viewing means for:
visualizing object images and/or processed images.

2. The system of claim 1, wherein the means for coding the reference points yield spatial the information based on the size of the unit elements; and yield the intensity information based on the number of intensity levels along the boundary.

3. The system of one of claims 1 or 2, wherein the means for coding the reference points represent each boundary unit element by a dipole of strength proportional to the size of the boundary unit element, centred at the reference points and oriented along the outward normal direction to the object boundary; and
the means for yielding the transform coefficients compute said coefficients from said dipoles for further representing said object boundary by a polynomial transform function using a finite number of said coefficients.

4. The system of one of claims 1 to 3, wherein the transform coefficients are Hermite transform coefficients.

5. The system of claim 4, wherein the computing means for computing transform coefficients from said dipoles comprise means for integrating the effect of each dipole into the transform coefficients, the contribution of each dipole being computed analytically knowing its position within the window, its strength and its orientation.

6. The system of one of claims 1 to 5, comprising means for smoothing the boundary of an object by varying the number of used transform coefficients.

7. The system according to one of claims 1 to 5, comprising means for comparing two corresponding boundaries of two different images of an object, by comparing their transform coefficients.

8. The system of claim 7, comprising means for matching two corresponding boundaries of two different images of an object, by matching their transform coefficients.

9. The system of claim 8, wherein the means for matching the transform coefficients of said boundaries comprises means for applying translation, rotation, scale change to the transform coefficients of one of the corresponding boundary of the object in one image.

10. The system of claim 8, comprising means for performing correlation of the corresponding boundaries of an object in different images by comparing the corresponding transform coefficients of the boundaries in the images and matching said transform coefficients.

11. The system of one of claims 6 to 10, comprising means for acquiring real image data for forming the two images of the object; or virtual image data for forming the two images of the object; or real image data for forming the first image of the object and virtual image data for forming the second image of the object; and
comprising means for comparing or matching or correlating corresponding boundaries of the different images of the object, by comparing or matching or performing correlation of corresponding coefficients of the real or virtual boundaries, including when necessary means for applying translation, rotation, scale change to the transform coefficients of at least one of the corresponding boundary of the object in one image.

12. An image processing method to cause the data processing means of the image processing system of one of claims 1 to 10 to perform steps of acquiring image data of an object in an image and characterizing a boundary of the object, comprising identifying the object boundary and reference points of said object boundary within an observation window; and decomposing said object boundary into boundary unit elements, centred at the reference points; this method further comprising steps of:
coding each reference point using coding data including spatial information and intensity information relating to said reference point and the corresponding unit element;
computing transform coefficients from said coding data;
representing said object boundary by a polynomial transform function using a finite number of said coefficients; and
visualizing object images and/or processed images.

13. A medical examination apparatus comprising acquisition means for acquiring medical image data, and an image processing system according to one of claims 1 to 10 for processing the medical image data.

14. A computer program product having a set of instructions, when in use on a general-purpose computer, to cause the computer to perform the steps of the method according to claim 11.
